(19) United States
(12) Patent Application Publication
(10) Pub. No.: US 2009/0162733 A1
(43) Pub. Date: Jun. 25, 2009

(54) FLOW FIELD PLATE FOR A FUEL CELL WITH FEATURES TO ENHANCE REACTANT GAS DISTRIBUTION

(76) Inventors: Eric J. Iverson, Eau Claire, WI (US); Thomas Herdtle, Inver Grove Heights, MN (US); Michael A. Yandrasits, Hastings, MN (US); Larry A. Schleif, Monticello, MN (US)

Correspondence Address: 3M INNOVATIVE PROPERTIES COMPANY, PO BOX 33427, ST. PAUL, MN, 55133-3427, US

(21) Appl. No.: 11/963,129

(22) Filed: Dec. 21, 2007

(51) Int. Cl. H01M 2/14; H01M 8/02

(52) U.S. Cl. 429/35

(57) ABSTRACT

A flow field plate for a fuel cell includes features in the gas input area that enhance gas distribution to the flow field channels. The input area of the flow field plate directs gases from an input manifold to the flow field channels. The input area includes one or more input channels which are defined by input channel walls. One or more features are included within the input area to enhance the distribution of the gas to the flow field channels. The gas distribution enhancement features may provide support for a sealing element to reduce blockage of the channels and/or may provide a path for fluid communication between adjacent input channels.

### FIELD OF THE INVENTION

The present invention relates generally to a flow field separator including gas distribution features that reduce blockage of gases in the flow field plate.

### BACKGROUND OF THE INVENTION

A typical fuel cell system includes a power section in which one or more fuel cells generate electrical power. A fuel cell is an energy conversion device that converts hydrogen and oxygen into water, producing electricity and heat in the process. Each fuel cell unit may include a proton exchange member (PEM) with gas diffusion layers on either side of the proton exchange member. Anode and cathode catalyst layers are respectively positioned between the gas diffusion layers and the PEM. This unit is referred to as a membrane electrode assembly (MEA). Separator plates (also referred to herein and flow field plates or bipolar plates) are respectively positioned on the outside of the gas diffusion layers of the membrane electrode assembly. This type of fuel cell is often referred to as a PEM fuel cell.

The reaction in a single MEA typically produces less than one volt. Therefore, to obtain operating voltages useful in most applications, a plurality of the MEAs may be stacked and electrically connected in series to achieve a desired voltage. Electrical current is collected from the fuel cell stack and used to drive a load. Fuel cells may be used to supply power for a variety of applications, ranging from automobiles to laptop computers.

The efficiency of the fuel cell power system depends on the flow of reactant gases across the surfaces of the MEA as well as the integrity of the various contacting and sealing interfaces within individual fuel cells of the fuel cell stack. Such contacting and sealing interfaces include those associated with the transport of fuels, coolants, and effluents within and between fuel cells of the stack. Proper positional alignment of fuel cell components and assemblies within a fuel cell stack is critical to ensure efficient operation of the fuel cell system.

### SUMMARY OF THE INVENTION

Embodiments of the invention involve a flow field plate for a fuel cell having features that enhance gas distribution in the flow field channels. The flow field plate includes an input area providing fluid communication between an input manifold and the flow field channels of the flow field plate. The flow field channels are disposed on at least a first surface of the flow field plate and are configured to distribute the reactant gas substantially evenly over a gas diffusion layer. The input area includes one or more input channels which are defined by input channel walls. The input channels direct the reactant gas from the input manifold to one or more of the flow field channels. One or more features of the input area enhance distribution of the reactant gas to the flow field channels. The gas distribution enhancement features may provide support for a sealing element to reduce blockage of the channels and/or may provide an alternate a path for fluid communication between adjacent input channels in the event a blockage occurs.

The gas distribution enhancement features may be located in a seal region of the input area. In some embodiments, the gas distribution enhancement features comprise seal support features. For example, the seal support features may be positioned within one or more of the input channels and/or aligned relative to gaps in the input channel walls and/or may be positioned within the gaps in the input channel walls. According to one aspect, a first group of the seal support features differs from a second group of seal support features. For example, one group of the seal support features may differ in one of both of cross sectional area and shape from a second group of the seal support features.

In some embodiments, the gas distribution enhancement features include gaps in one or more input channel walls. The gaps provide a path for gas flow between adjacent input channels. In one implementation, at least one channel wall of each input channel includes multiple discontinuities. In one implementation, at least two channel walls include the gaps and the gaps are staggered.

Another embodiment of the invention is directed to a fuel cell assembly. The fuel cell assembly includes a fuel cell membrane electrode assembly (MEA), comprising first and second gas diffusion layers (GDLs), and a membrane provided between anode and cathode catalytic layers. A sealing system is arranged relative to a periphery of the MEA. The fuel cell assembly includes first and second flow field plates arranged relative to the MEA and the sealing system.

Gas flow to the flow field of each flow field plate is facilitated by a manifold. A pattern of flow field channels is disposed on at least one surface of the flow field plates, the flow field channels are arranged in a pattern to distribute a reactant gas substantially evenly over an adjacent GDL. The flow field plates include an input area between the manifold and the flow field channels. The input area comprises one or more input channels each defined by input channel walls. The input channels are configured to direct the reactant gas from the input manifold to one or more flow field channels. The input area also includes one or more features that enhance distribution of the reactant gas to the flow field channels. The gas distribution enhancement features provide one or both of support for a sealing element to reduce blockage of the input channels and a path for fluid communication between adjacent input channels.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### BRIEF DESCRIPTION OF THE DRAWINGS

FIG. 1 is an illustration of a fuel cell and its constituent layers;

FIG. 2 provides an exploded diagram of a fuel cell including flow field plates configured in accordance with embodiments of the present invention;

FIG. 3 provides an exploded diagram of a fuel cell stack that includes unipolar and bipolar flow field plates in accordance with embodiments of the invention;

FIG. 4A shows a plan view of a flow field plate in accordance with embodiments of the invention;

FIG. 4B illustrates a flow field plate input area in accordance with embodiments of the invention;

FIG. 5A illustrates the input area of a flow field plate including input channels that supply gas to the flow field channels.

FIG. 5B is a cross sectional view of a flow field plate input area illustrating blockage of the input channels by a seal;

FIGS. 6A and 6B show plan and cross sectional views, respectively, of a flow field plate having seal support features arranged in the reactant gas input channels to support a seal and reduce input channel blockage in accordance with an embodiment of the invention; and

FIG. 7 illustrates an flow field plate input area having input channels with discontinuous channel walls forming gaps that provide a path for reactant gas to flow between adjacent channels in accordance with embodiments of the invention;

FIGS. 8-9 illustrate flow field plates having seal support features and discontinuous channel walls in a reactant gas input area in accordance with various embodiments.

While the invention is amenable to various modifications and alternative forms, specifics thereof have been shown by way of example in the drawings and will be described in detail. It is to be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF VARIOUS EMBODIMENTS

In the following description of the illustrated embodiments, reference is made to the accompanying drawings that form a part hereof, and in which is shown by way of illustration, various embodiments in which the invention may be practiced. It is to be understood that other embodiments may be utilized and structural changes may be made to the illustrated embodiments without departing from the scope of the present invention.

Embodiments of the invention are directed to flow field plates that incorporate features providing enhanced gas distribution in the reactant gas input area of the flow field plate. In some embodiments, the features include input channel wall discontinuities resulting in gaps that allow flow of reactant gases or other fluids between adjacent input channels. In some embodiments, the features include support features within the channel and/or within the channel wall gaps that provide support for a sealing element, such as a gasket or o-ring. In embodiments that include discontinuous channel walls, the arrangement of the features may provide for both supporting the sealing element while also allowing gas flow between adjacent channels. It will be appreciated that many configurations of features for enhancing gas distribution are possible. Accordingly, the specific illustrative embodiments described below are for purposes of explanation, and not of limitation.

A flow field plate of the present invention may be incorporated in fuel cell assemblies and stacks of varying types, configurations, and technologies. For example, a flow field separator including features for enhancing gas distribution can be employed in proton exchange membrane (PEM) fuel cell assemblies. PEM fuel cells operate at relatively low temperatures, have high power density, can vary their output quickly to meet shifts in power demand, and are well suited for applications where quick startup is required, such as in automobiles for example.

Although generally illustrated herein in conjunction with PEM fuel cells, flow field separators in accordance with embodiments of the invention may also be employed in other types of fuel cells, including direct methanol fuel cells (DMFC). Direct methanol fuel cells are similar to PEM cells in that they both use a polymer membrane as the electrolyte. In a DMFC, however, the anode catalyst itself draws the hydrogen from liquid methanol fuel, eliminating the need for a fuel reformer.

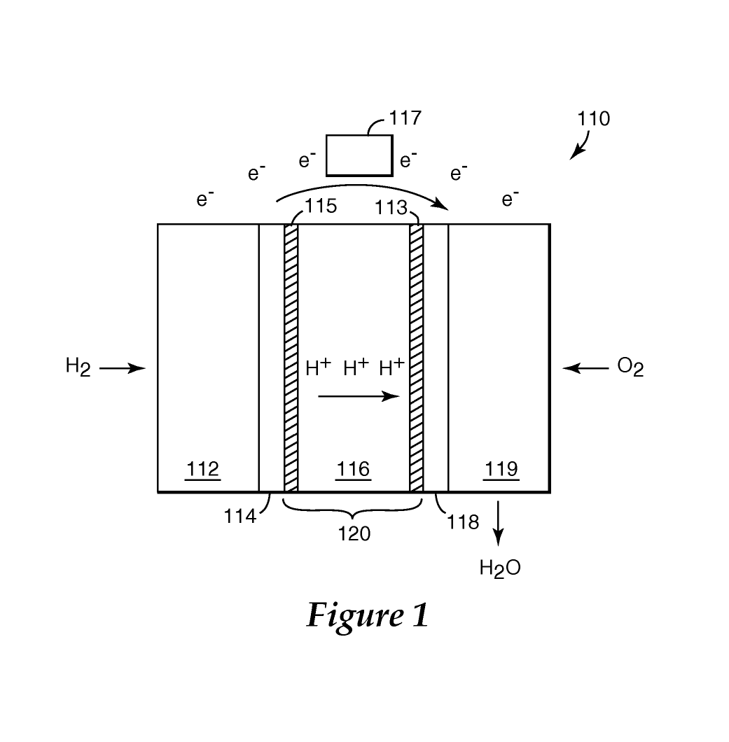

A typical proton exchange member fuel cell is depicted in FIG. 1. The fuel cell 110 shown in FIG. 1 includes a first flow field plate 112 adjacent a first gas diffusion layer (GDL) 114. Adjacent the GDL 114 is a catalyst coated membrane (CCM) 120. A second GDL 118 is situated adjacent the CCM 120, and a second flow field plate 119 is situated adjacent the second GDL 118.

In operation, hydrogen fuel is introduced into the anode portion of the fuel cell 110, passing over the first flow field separator 112 and through the GDL 114. At the interface of the GDL 114 and the CCM 120, on the surface of the catalyst layer 115, the hydrogen fuel is separated into hydrogen ions (H⁺) and electrons (e⁻).

The electrolyte membrane 116 of the CCM 120 permits only the hydrogen ions or protons and water to pass through the electrolyte membrane 116 to the cathode catalyst layer 113 of the fuel cell 110. The electrons cannot pass through the electrolyte membrane 116 and, instead, flow through an external electrical circuit in the form of electric current. This current can power an electric load 117, such as an electric motor, or be directed to an energy storage device, such as a rechargeable battery.

Oxygen flows through the second GDL 118 at the cathode side of the fuel cell 110 via the second flow field separator 119. On the surface of the cathode catalyst layer 113, oxygen, protons, and electrons combine to produce water and heat.

Individual fuel cells, such as the fuel cell shown in FIG. 1, can be combined to form a fuel cell stack. The number of fuel cells within the stack determines the maximum voltage of the stack, and the surface area of each of the cells determines the maximum current. In general, the electrical power produced by a given fuel cell stack can be determined by multiplying the total stack voltage by total current. The voltage and/or current produced by the cell can be controlled by electrical demand and/or reactant fuel rates. Thus, the actual power generated by the cell may not be the total possible power.

Sealing the fuel, oxidant, coolants, and other fluids within each fuel cell in a stack is critical to the efficient operation of the fuel cell stack. Gaskets are typically deployed around the perimeter of the active area of the electrolyte membrane. Gaskets may be placed on one or both surfaces of the electrolyte membrane and/or on one or both catalyst layers and/or on one or both surfaces of the gas GDLs. The gaskets are important to seal against leaks in the peripheral areas and/or edges of the electrolyte membrane, GDLs and the flow field plates that face the GDLs. In some configurations, a sealing system may include both gaskets and o-rings. The sealing system can bridge the gas input areas of the flow field plates as described in more detail below.

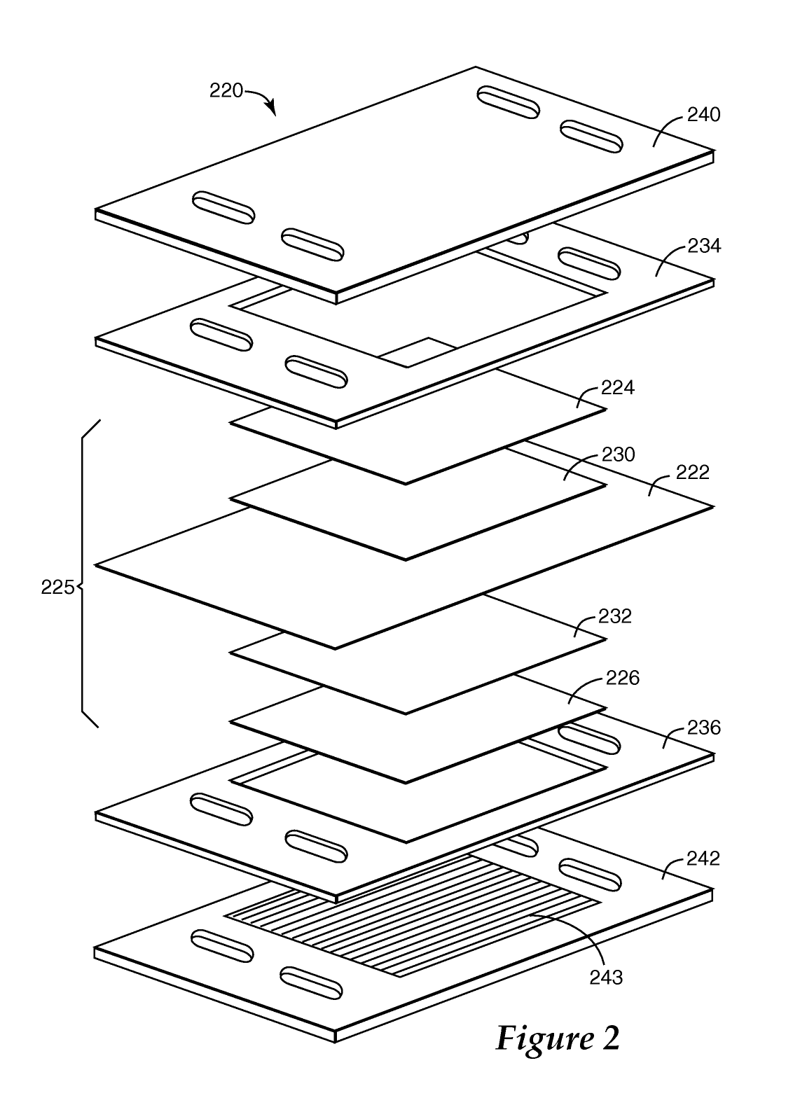

FIG. 2 shows an exploded diagram of the components of a fuel cell that includes flow field plates in accordance with embodiments of the invention. As is shown in FIG. 2, a membrane electrode assembly (MEA) 225 of the fuel cell 220 includes five component layers. An electrolyte membrane layer 222 is sandwiched between a pair of GDLs 224 and 226. An anode catalyst layer 230 is situated between a first GDL 224 and the membrane 222, and a cathode catalyst layer 232 is situated between the membrane 222 and a second GDL 226.

In one configuration, a membrane layer 222 is fabricated to include an anode catalyst coating 230 on one surface and a cathode catalyst coating 232 on the other surface. This structure is often referred to as a catalyst-coated membrane or CCM. The GDLs 224, 226 can be fabricated to include or exclude a catalyst coating. In one configuration, an anode catalyst coating 230 can be disposed partially on the first GDL 224 and partially on one surface of the membrane 222, and/or a cathode catalyst coating 232 can be disposed partially on the second GDL 226 and partially on the other surface of the membrane 222.

In the particular embodiment shown in FIG. 2, MEA 225 is shown sandwiched between a first edge sealing system 234 and a second edge sealing system 236. Adjacent the first and second edge sealing systems 234 and 236 are flow field plates 240 and 242, respectively. Each of the flow field separators 240, 242 includes a field of fluid flow channels 243 and manifolds through which hydrogen and oxygen feed fuels pass.

In the configuration depicted in FIG. 2, flow field plates 240, 242 are configured as unipolar flow field plates, also referred to as monopolar flow field plates, in which a single MEA 225 is sandwiched therebetween. A unipolar flow field plate may comprise a separator that includes a flow field side and a cooling side. The flow field side incorporates a field of gas flow channels 243 and manifolds through which hydrogen or oxygen feed fuels pass. The cooling side incorporates a cooling arrangement, such as integral cooling channels. Alternatively, the cooling side may be configured to contact a separate cooling element, such as a cooling block or bladder through which a coolant passes or a heat sink element, for example.

The edge seal systems 234, 236 provide the necessary sealing within the fuel cell to isolate the various fluid (gas/liquid) transport and reaction regions from contaminating one another and from inappropriately exiting the fuel cell 220, and may further provide for electrical isolation and/or hard stop compression control between the flow field plates 240, 242. The term “hard stop” generally refers to a nearly or substantially incompressible material that does not significantly change in thickness under operating pressures and temperatures. More particularly, the term “hard stop” refers to a substantially incompressible member or layer in a membrane electrode assembly (MEA) which halts compression of the MEA at a fixed thickness or strain.

The sealing systems 234, 236, may employ one or more gaskets, sub-gaskets and/or O-rings to effect sealing of the edges of the MEA 225 and sealing between and around the MEA 225 and the flow field separators 240, 242. In one configuration, the sealing systems 234, 236 include a gasket system formed from one, two or more layers of various selected materials employed to provide the requisite sealing within the fuel cell 220. Such materials include, for example, TEFLON, fiberglass impregnated with TEFLON, an elastomeric material, UV curable polymeric material, surface texture material, multi-layered composite material, sealants, and silicon material. Other configurations employ an in-situ formed seal system.

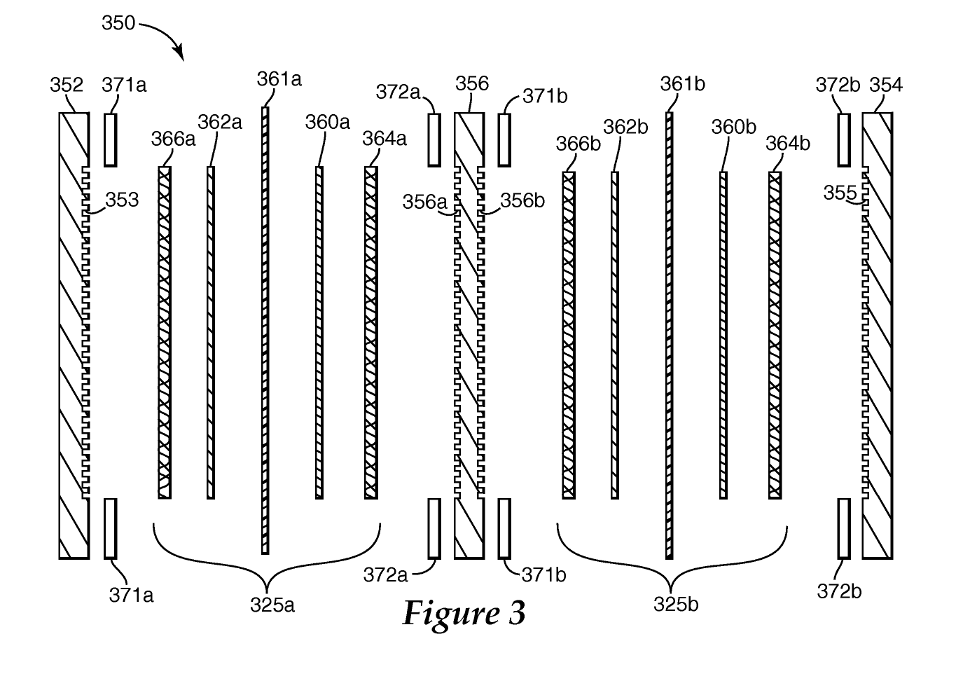

In certain embodiments, a fuel cell stack may use bipolar flow field plates, as illustrated in FIG. 3. FIG. 3 illustrates a fuel cell stack 350 which incorporates multiple MEAs 325 through employment of unipolar flow field plates 352, 354 and one or more bipolar flow field plates 356. In the configuration shown in FIG. 3, a two-cell stack 350 incorporates two MEAs 325a and 325b and a single bipolar flow field plate 356. MEA 325a includes a cathode 362a/membrane 361a/anode 360a layered structure sandwiched between GDLs 366a and 364a. GDL 366a is situated adjacent a flow field end plate 352, which is configured as a unipolar flow field plate. GDL 364a is situated adjacent a first flow field surface 356a of bipolar flow field plate 356. Sealing system 371a is deployed to provide sealing for MEA 325a and flow field end plate 352. Sealing system 372a is deployed to provide sealing for MEA 325 and bipolar flow field plate 356.

Similarly, MEA 325b includes a cathode 362b/membrane 361b/anode 360b layered structure sandwiched between GDLs 366b and 364b. GDL 364b is situated adjacent a flow field end plate 354, which is configured as a unipolar flow field plate. GDL 366b is situated adjacent a second flow field surface 356b of bipolar flow field plate 356. Sealing systems 371b and 372b are deployed to provide sealing for MEA 325b and flow field end plate 354 and MEA 325 and bipolar flow field plate 356, respectively.

It will be appreciated that in other configurations, N number of MEAs 325 and N−1 bipolar flow field plates 356 can be incorporated into an N-cell fuel cell stack.

The fuel cell and/or stack configurations shown in FIGS. 2-3 are representative of two particular arrangements that can be implemented for use in the context of the present invention. These arrangements are provided for illustrative purposes only, and are not intended to represent all possible configurations coming within the scope of the present invention. Rather, FIGS. 2-3 are intended to illustrate various components that can be selectively incorporated into fuel cell assemblies that include flow field plates with gas distribution features according to principles of the present invention. Embodiments of the invention are directed to flow field plates having features that enhance gas distribution to the flow field region of a flow field plate. As will be readily appreciated such features may be provided on the flow field side of a unipolar flow field plate, or may be provided on both sides of a bipolar flow field plate. In addition, the distribution features discussed herein may used to enhance coolant distribution for a coolant flow field, such as a coolant flow field disposed on one side of a unipolar flow field plate.

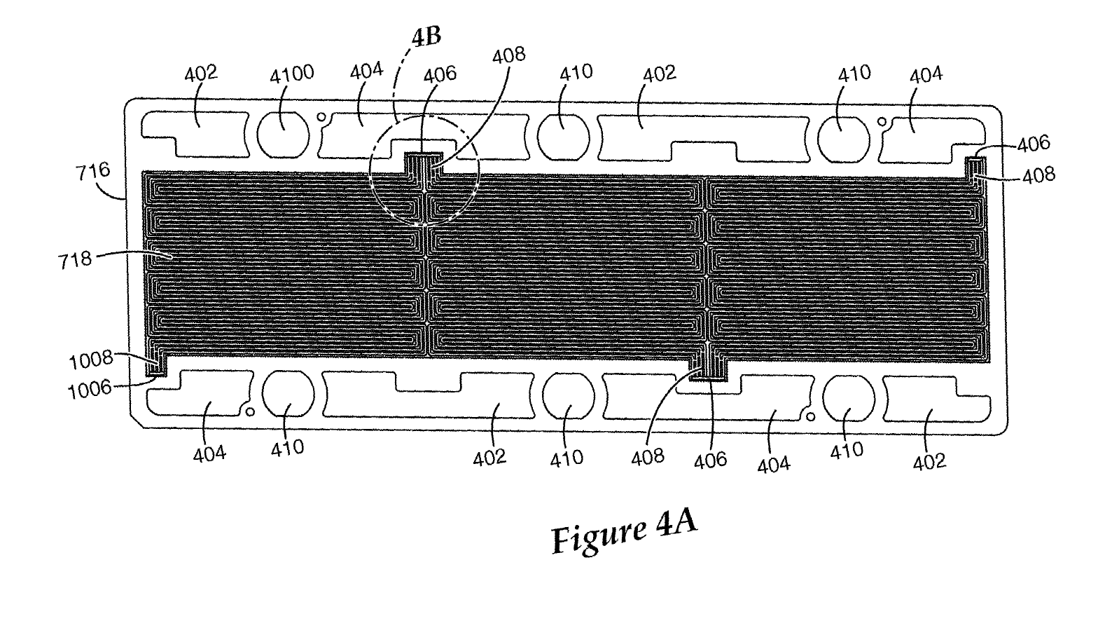

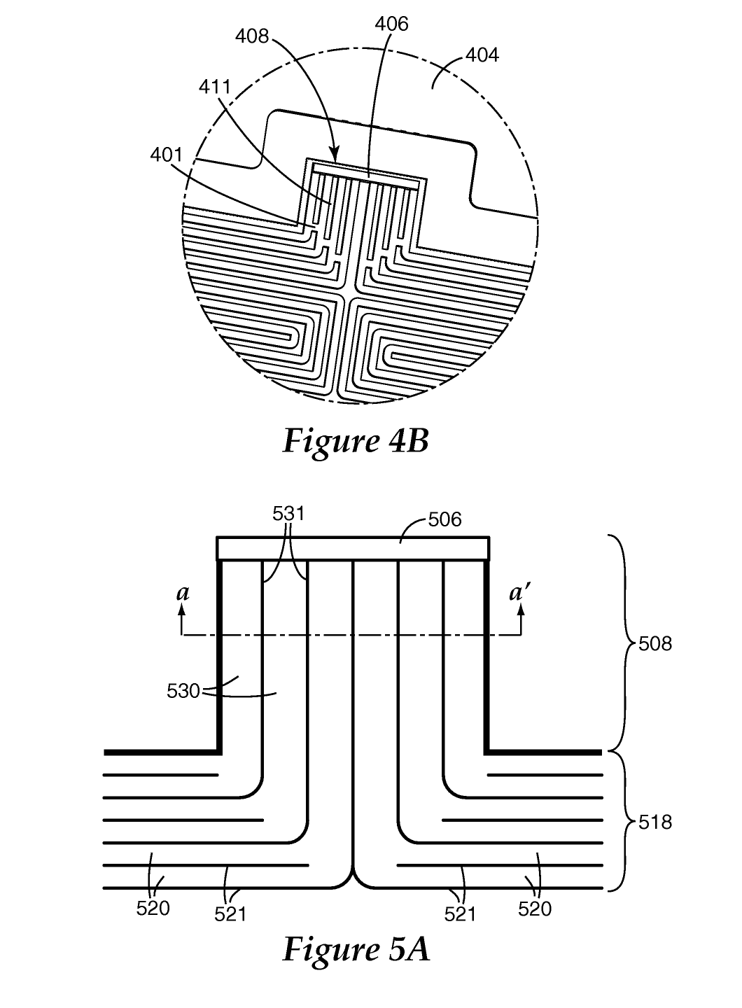

FIG. 4A is a view of a flow field plate 400 in accordance with embodiments of the present invention. The flow field plate 400 may be formed from titanium alloys for maximum strength, light weight, and corrosion resistance. The flow field plate 400 may also be formed from nickel-chromium alloys that are coated with a thin solid layer of CrN or TiN to improve corrosion resistance. The side of the plate 400 visible in this view includes the flow field 418 that is formed onto the surface of the plate 400. In this example, the flow field plate 400 is a cathode plate, wherein the flow field 418 provides for substantially even cathode gas distribution over the surface of an adjacent GDL. A similar configuration may be used for an anode plate. The plate 400 includes a series of coolant manifolds 410, anode gas manifolds 402, and cathode gas manifolds 404 to facilitate flow of coolant and gases. Openings 406 couple the cathode manifolds to an input area 408. The input area includes one of or input channels that form part of an input flow path that allows passage of reactant gases between the input manifolds and the 404 flow field 418.

Embodiments of the invention are directed to features provided in the input area 408 of the flow field plate 400 that enhance distribution of gases that flow between the openings 406 the flow field 418. The input area is shown in enlarged detail in FIG. 4B. A sealing system involving one or more gaskets and/or O-rings may bridge the input channels of the input area 408. A problem arises when a gasket or o-ring used is sufficiently flexible that it does not remain above the input channels, but over time or under pressure portions of the gasket or o-ring sags or “tents” into the input channels. The sagging gasket or o-ring may fully or partially block an input channel, causing one or more channels of the flow field 418 which are fed by that input channel to be starved for fuel.

Features incorporated into the input area 408 in accordance with various embodiments involve gaps 401 in the input channel walls 411 that provide a path for gas to flow between adjacent input channels. In the event that one input channel becomes blocked, an adjacent, unblocked input channel in the input area 408 can provide reactant gas to the blocked channel.

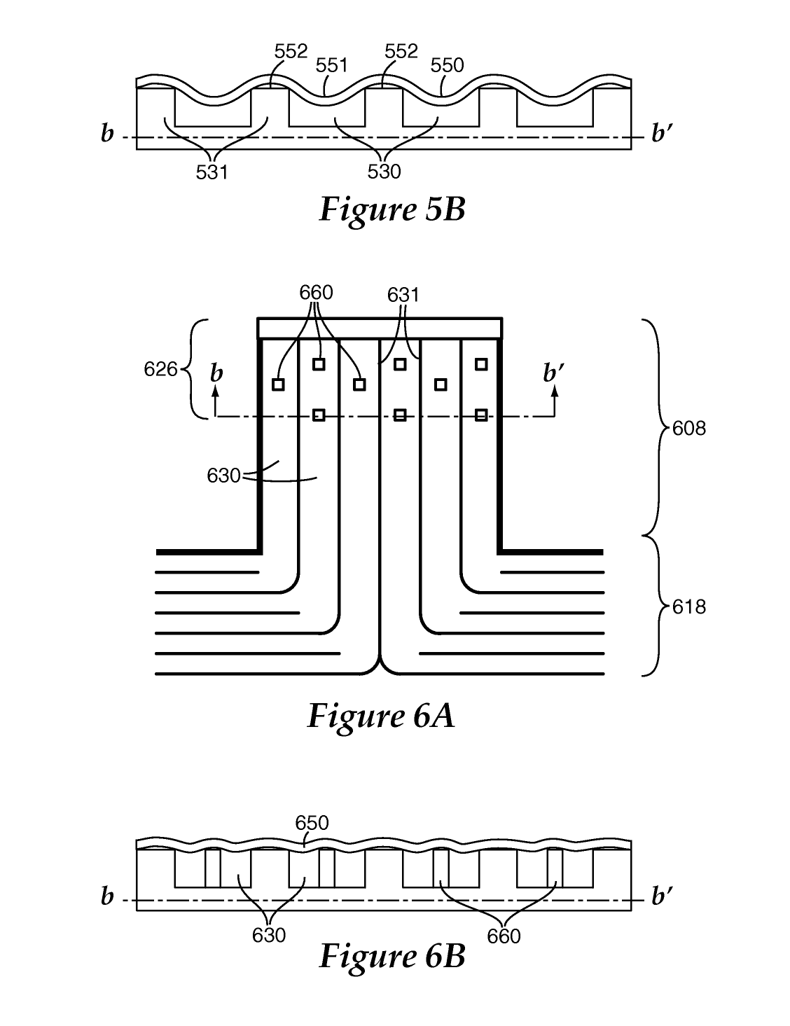

FIG. 5A illustrates a top view of the input area 508 and a portion of the flow field 518 of a flow field plate. The input area 508 includes one or more openings 506 that supply gas from the manifold to the flow field plate. The input area 508 includes one or more input channels 530 which are separated by input channel walls 531. The input channels distribute gases that are input through the opening 506 to the flow field 518. The flow field 518 includes a plurality of flow field channels 520 separated by flow field channel walls 521. The flow field channels 520 of the flow field 518 are proximate the GDL (not shown) and distribute gases substantially evenly over the GDL.

FIG. 5B shows a portion of a cross section of the input area 508 of a flow field plate taken through line a-a′ indicated on FIG. 5A. FIG. 5B also depicts a gasket 550 which, in FIG. 5B is placed above the input area, and is used for sealing the fuel cell. FIG. 5B illustrates the problem caused by gasket tenting. In this illustration, the gasket material is not rigid enough to sustain its shape and remain in line above the tops 532 of the channel walls 531. Over time and/or under pressure, portions 551 of the gasket 550 sag into the input channels 530. As previously discussed, this phenomenon may result in partially or fully blocked input channels causing degraded gas distribution from the input channels to the flow field channels of the flow field.

Embodiments of the invention illustrate various configurations of features arranged in the input area of a flow field plate that provide enhanced gas distribution to the flow field. In some embodiments, as illustrated in the plan view of FIG. 6A and the cross section of FIG. 6B, the input area 608 includes support features 660 positioned within one or more of the input channels 630. In one configuration, the input area 608 includes input channels defined by channel walls 631 which are continuous, and one or more support features 660 are arranged within one or more of the input channels 630. As is best seen in FIG. 6B, the support features 660 serve to reduce sagging of the gasket 650 into the input channels 630 in a seal region 628 of the input area 608. The support features 660 prevent or reduce blockages of the input channels 630 which block or reduce gas distribution to the flow field 618.

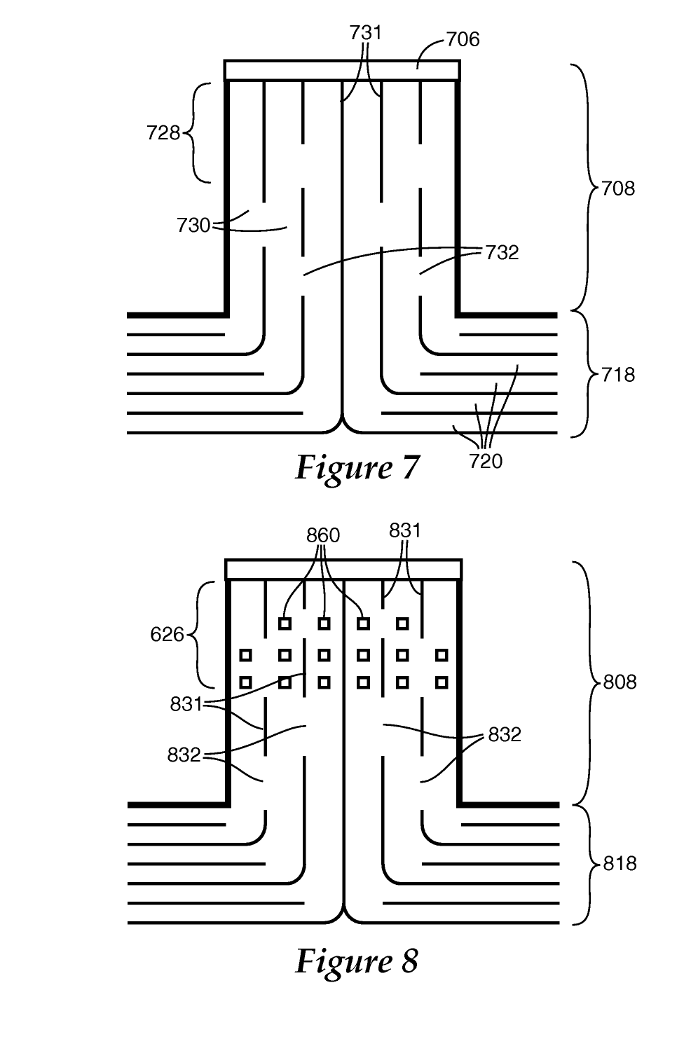

In some embodiments, the features which enhance gas distribution comprise discontinuities in the input channel walls. FIG. 7 depicts a plan view of one embodiment that incorporates input channels 730 with discontinuous input channel walls 731. One or more of the input channel walls 731 is discontinuous. The discontinuities form one or more gaps 732 in the walls 731 between adjacent channels 730. The gaps 732 may be arranged so that they are situated in the input area 708 and beyond the region 728 covered by the gasket. The gaps 732 allow gases to flow between adjacent input channels 730 with very low resistance. In some embodiments, multiple channel walls include gaps and the gaps may be staggered, as illustrated in FIG. 7. In the event one channel 730 becomes blocked, the gaps in the channel wall between the blocked channel and an adjacent channel. Through this path, the flow field channels normally supplied by the blocked channel are supplied via the adjacent channel.

In some embodiments, as illustrated in FIG. 8, the features enhancing gas distribution to the flow field 818 may include both discontinuous input channel walls 831 and support features 860 positioned within the input channels 830. The discontinuous input channel walls 831 include gaps 820 arranged in the input area 808 and beyond the seal region 828. As previously discussed, the gaps 820 allow gas flow to a blocked channel from an adjacent unblocked channel. The support features 860 may be used in conjunction with the discontinuous channel walls. The support features are positioned within the seal region 828 of the input area 808 to reduce the occurrence of blockages due to sagging of the seal into the input channels 830.

The support features may take on any shape that provides support for the seal and allow low resistance gas flow. In some configurations, a first group of support features may differ from another group of support features in shape and/or cross sectional area. One or both of the support feature groups may be aligned relative to gaps in the input channel walls.

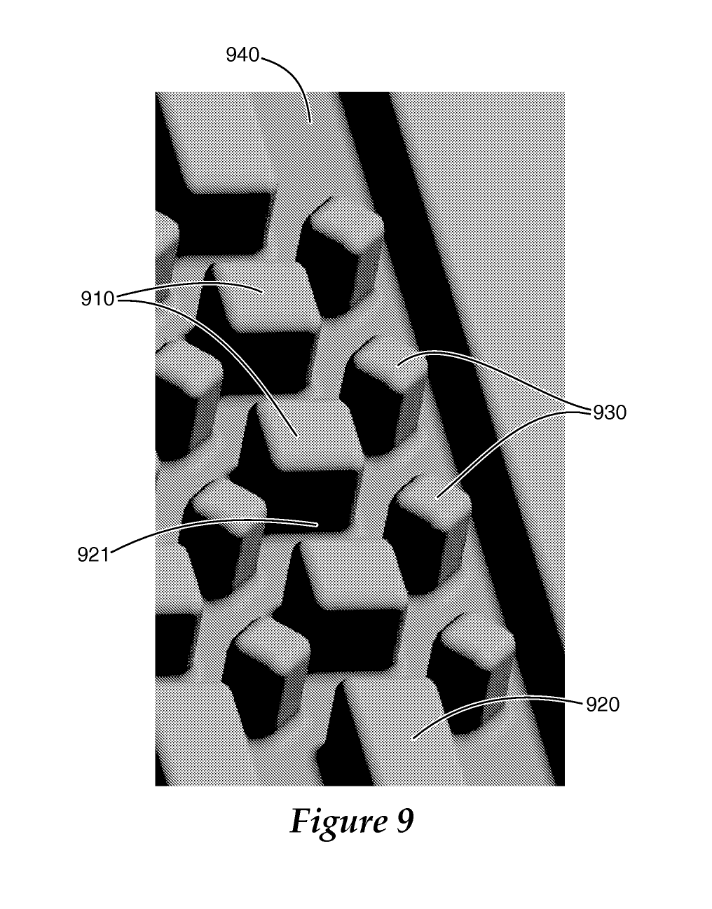

FIG. 9 depict in perspective view the input area of a flow field plate having two groups of support features. A first group of support features 910 are arranged within the gaps 921 of one or more discontinuous input channel walls 920. A second group of the support features 930 are arranged within the input channels 940.

The use of support features and/or discontinuous channel walls within the input area of a flow field plate allows more even distribution of reactant gases to the flow field. If an input channel is blocked or restricted, then regions of the fuel cell are starved of reactants and will start to drop in voltage or become unstable. In a blockage situation, the voltage of the blocked cell can drop below that of the neighboring cells causing premature failure of the entire fuel cell stack. The use of gas distribution enhancement features, including seal support features and/or discontinuous input channel walls, advantageously reduces the occurrence of blockages and/or provides alternate paths for supplying gas to the flow field in the event an input channel becomes blocked.

The foregoing description of the various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What we claim is:

1. A flow field plate for a fuel cell, comprising:
a flow field disposed on at least a first surface of the flow field plate, the flow field including flow field channels configured to distribute a gas supplied via an input manifold substantially evenly over a gas diffusion layer; and
an input area arranged between the input manifold and the flow filed, the input area comprising a plurality of input channels, each input channel defined by input channel walls and configured to direct the gas to one or more flow field channels, the input area including one or more features that enhance distribution of the fluid to the flow field channels, the one or more gas distribution enhancement features providing one or both of support for a sealing element to reduce blockage of the channels and a path for fluid communication between adjacent input channels.

2. The flow field plate of claim 1, wherein the gas distribution enhancement features are located in a seal region of the input area.

3. The flow field plate of claim 1, wherein the gas distribution enhancement features comprise gaps in the input channel walls which provide the path for fluid communication between adjacent input channels.

4. The flow field plate of claim 1, wherein the gas distribution enhancement features comprise seal support features positioned within one or more of the input channels.

5. The flow field plate of claim 4, wherein a first group of the seal support features differs in one of both of cross sectional area and shape from a second group of the seal support features.

6. The flow field plate of claim 1, wherein the gas distribution enhancement features comprise both gaps in the input channel walls and seal support features.

7. The flow field plate of claim 1, wherein the seal support features are aligned relative to the gaps in the input channel walls.

8. The flow field plate of claim 1, wherein the seal support features are positioned within the gaps in the input channel walls.

9. The flow field plate of claim 1, wherein at least one channel wall of each input channel includes multiple discontinuities.

10. The flow field plate of claim 9, wherein at least two channel walls include the gaps and the gaps are staggered.

11. A fuel cell assembly, comprising:
a fuel cell membrane electrode assembly (MEA), the MEA comprising first and second gas diffusion layers (GDLs) and a membrane between anode and cathode catalytic layers;
a sealing system arranged relative to a periphery of the MEA;
a first flow field plate arranged relative to a first surface of the MEA and a first surface of the gasket; and
a second flow field plate arranged relative to a second surface of the MEA and a second surface of the gasket, at least one of the flow field plates comprising:
a flow field disposed on at least a first surface of the flow field plate, the flow field including flow field channels configured to distribute a gas substantially evenly over an adjacent GDL; and
an input area arranged between an input manifold and the flow field channels, the input area comprising a plurality of input channels, each input channel defined by input channel walls and configured to direct the gas from the input manifold to one or more flow field channels, the input area including one or more features that enhance distribution of the gas to the flow field channels, the one or more gas distribution enhancement features providing one or both of support for the sealing system to reduce blockage of the channels and a path for fluid communication between adjacent input channels.

12. The fuel cell assembly of claim 11, wherein the gas distribution enhancement features are located in a seal region of the input area.

13. The fuel cell assembly of claim 11, wherein the gas distribution enhancement features comprise gaps in at least one input channel wall which provide the path for fluid communication between the adjacent input channels.

14. The fuel cell assembly of claim 13, wherein at least two input channel walls include gaps and the gaps are staggered.

15. The fuel cell assembly of claim 11, wherein the gas distribution enhancement features comprise seal support features positioned within one or more of the input channels.

16. The fuel cell assembly of claim 15, wherein a first group of the seal support features differs in one of both of cross sectional area and shape from a second group of the seal support features.

17. The fuel cell assembly of claim 11, wherein the gas distribution enhancement features comprise both gaps in the input channel walls and seal support features.

18. The fuel cell assembly of claim 17, wherein the seal support features are aligned relative to the gaps in the input channel walls.

19. The fuel cell assembly of claim 17, wherein the seal support features are positioned within the gaps in the input channel walls.

20. The fuel cell assembly of claim 11, wherein the flow field plates are unipolar.

21. The fuel cell assembly of claim 11, wherein at least one of the flow field plates is bipolar and includes gas distribution enhancement features on both surfaces of the bipolar plate.
